(19) United States
(12) Patent Application Publication
(10) Pub. No.: US 2002/0184416 A1
(43) Pub. Date: Dec. 5, 2002

(54) Personal computer radio receiver

(75) Inventor: Gal Ben-David, Mitzpe Adi (IL)

Correspondence Address: DR. MARK FRIEDMAN LTD., C/O Bill Polkinghorn, Discovery Dispatch, 9003 Florin Way, Upper Marlboro, MD, 20772, US

(73) Assignee: SMARTEC SUBSIDIARY LTD.

(21) Appl. No.: 10/061,314

(22) Filed: Feb. 4, 2002

Related U.S. Application Data
(60) Provisional application No. 60/284,516, filed on Apr. 19, 2001.

(51) Int. Cl. G06F 13/12

(52) U.S. Cl. 710/73

(57) ABSTRACT

A system for the combined input of data into a personal computer and for reception of wireless radio-frequency signals uses the PS/2 mouse interface for radio control in a way that does not interfere with normal mouse operation. The system includes both hardware and software. The hardware can be an integrated device with both computer mouse and radio capabilities united in one physical unit, or a non-integrated device comprised of separate mouse and radio units. In both integrated and non-integrated embodiments, the device is connected to a PS/2 port of the computer. The system uses an enhanced protocol for combined data input into the computer and for radio features, and includes a special mouse driver used for performing the enhanced protocol.

### CROSS REFERENCE TO RELATED APPLICATIONS

The present application claims the benefit of priority from U.S. Provisional Application No. 60/284,516, filed Apr. 19, 2001, the contents of which are incorporated herein by reference.

### FIELD AND BACKGROUND OF THE INVENTION

The PS/2 mouse and keyboard were introduced by IBM together with its PS/2 computer family, around 1987. Prior to this, the XT and AT and almost all clones used the larger full-size 5-pin DIN keyboard connector. The PS/2 line also introduced the PS/2 mouse—prior to this almost all mice were either plugged into a standard serial port, or they were plugged into their own controller card, like the Microsoft Bus Mouse. The PS/2 mouse is currently the industry standard and is one of the main input devices in the Microsoft Windows environment. Therefore it may be assumed that almost all home and office personal computer systems have two PS/2 connectors, one for the keyboard and one for the mouse.

Most modern computer systems are shipped with a sound card and speakers as a standard feature. The use of the sound card is currently limited to games and a few system alerts. On the other hand, a very small number of computer systems include a radio receiver. A radio receiver is one of the everyday devices used for information and entertainment. Since the radio is not a part of the standard computer, it is sold as an add-on. In order to use the computer user interface for radio control, the radio must be connected to the motherboard as an extension card, or by using one of the external ports. An extension card has a number of major drawbacks: it forces the end-user to open the computer, and it occupies one of a limited number of PCI or ISA slots. Using a dedicated computer port (Serial Port, Printer Port, USB port, etc.) for the sole purpose of radio may be problematic, because of the limited number of ports that exist, and because some may be needed for other peripherals (keyboard, printer, scanner, digital camera, eta.).

The development of mouse and graphical user interfaces started at Xerox, and was further developed by Apple Computer. The PS/2 mouse subsystem has the following parts: Motion sensors and switches, mouse controller, PS/2 Communication link, keyboard/mouse controller, mouse driver and a Windows application that acts following mouse movements and buttons. The motion sensors (typically opto-mechanical) sense the mouse movement, and button switches sense the button states. The mouse controller reads the state of those sensors and tracks the present mouse position. When this information changes, the mouse controller sends a packet of data to the computer data interface controller. The packet transmission rate is limited by a parameter defined by the mouse and by the Windows (or other) operating system (around 100-200 packets a second). The mouse driver in the computer receives that data packet, decodes the information from it, and moves the cursor based on the information. Typically, the mouse driver has the information of the present mouse state (position and button states), and it informs the application or operating system on a timely basis. Typically the mouse drive calls mouse cursor moving routines when the mouse is moved, and sends messages to the software when the buttons are pressed.

In a typical modem PC mouse driver, the actual cursor movement is not linearly related to the mouse movement. During the pioneering research done at Xerox and Apple Computer in the development of the graphical user interface (GUI), it became apparent that no particular ratio between mouse movement and cursor movement was best suited for all tasks. Early work detected that there are two basic movements in the use of pointing devices: move a cursor to a desired area, and then move it exactly to a desired target. Those two movements have contradictory requirements, so Apple solved the problem by monitoring the mouse movements and by changing its CPI (counts per inch) characteristics. When the mouse is moved slowly, it remains 100 CPI, and when the mouse is moved fast, it behaves as a 400 CPI mouse.

The PS/2 mouse is connected to the computer motherboard using the same type of 6-pin connector as the PS/2 keyboard. The data is sent using a synchronous serial protocol similar to the protocol used by the PS/2 keyboard. The mouse data is handled using a keyboard controller. The PS/2 type mouse is becoming more and more common because most new computers have an integrated PS/2 mouse port, and are using a PS/2 mouse connected to that port (which also frees one serial port for other uses).

In view of the existing problems and disadvantages listed above, there is a need for, and it would be highly advantageous to have, a simple and inexpensive combined computer mouse plus radio system that can be easily hooked up to a computer using the regular PS/2 external port and the audio line-in, and operated in both radio and regular mouse modes by a single protocol.

### SUMMARY OF THE INVENTION

The present invention is of a system combining the functionality of a computer-pointing device (e.g. mouse) and a computer controlled radio receiver, and composed of both software and hardware. The system will henceforth be referred to in a general way as a Radio-Mouse system, or in short a “Radio-Mouse”. The hardware is an input device (such as a mouse or trackball) that includes components necessary for receipt of wireless radio-frequency transmissions and a micro controller. In particular, the input device is configured to receive FM/AM radio. The software is a computer program installed and operable on the computer to which the input device is connected. The function of the software is to control and to operate the wireless radio-frequency receiver including, but not limited to, frequency (channel) selection, recording parameters, and so forth.

The received wireless radio-frequency audio transmissions are made audible through devices known in the art (for example, a sound card and speakers) installed in the computer. Use of the device allows reception and display (auditing) of wireless radio-frequency signals on a personal computer without the need to purchase and install components inside the computer. Installation of the system of the present invention requires only the simple attachment of the input device through the standard input device ports, specifically a PS/2 port and an Audio-In port. The invention thus obviates the need for an internal radio card or an Internet connection.

According to the present invention there is provided a system for the combined input of data into a personal computer and for reception of wireless radio-frequency signals, comprising an integrated computer input device including a PS/2 interface and configured to receive wireless radio frequency signals, an enhanced protocol for controlling the reception of radio frequency signals while rendering transparent the input of data, and a special mouse driver used for performing the enhanced protocol, whereby the system uses the PS/2 mouse interface for radio control in a way that does not interfere with normal mouse operation.

According to the present invention there is provided a system for the combined input of data into a personal computer and for reception of wireless radio-frequency signals, comprising a computer input device including a PS/2 interface and a special microcontroller, a wireless radio frequency receiver device connected to the input device, an enhanced protocol for controlling the reception of radio frequency signals while rendering transparent the input of data, and a special mouse driver used for performing the enhanced protocol, whereby the system uses the PS/2 mouse interface for radio control in a way that does not interfere with normal mouse operation.

### BRIEF DESCRIPTION OF THE DRAWINGS

The invention is herein described, by way of example only, with reference to the accompanying drawings, wherein:

FIG. 1 is a schematic description of an embodiment of the Radio-Mouse system of the present invention in which radio components are integrated into a computer input device;

FIG. 2 is a schematic description of a second embodiment of the system of Radio-Mouse system of the present invention, in which a radio receiver device is physically separate from a computer input device;

FIG. 3 is a schematic block-diagram of a preferred embodiment of the Mouse-Radio system;

### DESCRIPTION OF THE PREFERRED EMBODIMENTS

The present invention is of a system based on a computer input device (generally referred to herein also as a “mouse”) configured to receive FM/AM radio transmissions through a wireless radio-frequency receiver. The system's functionality is similar to that of a Microsoft Intellimouse or similar device, but with an added functionality of a radio receiver. The Radio-Mouse system includes software and hardware. The function of the software is to control and to operate the wireless radio-frequency receiver including, but not limited to, frequency (channel) selection, recording parameters, etc. In terms of hardware, it is well known that a wireless radio-frequency receiver is made up of a number of components, including a receiver, an amplifier, a frequency filter, and an antenna.

The principles and operation of a Radio-Mouse system according to the present invention may be better understood with reference to the drawings and the accompanying description.

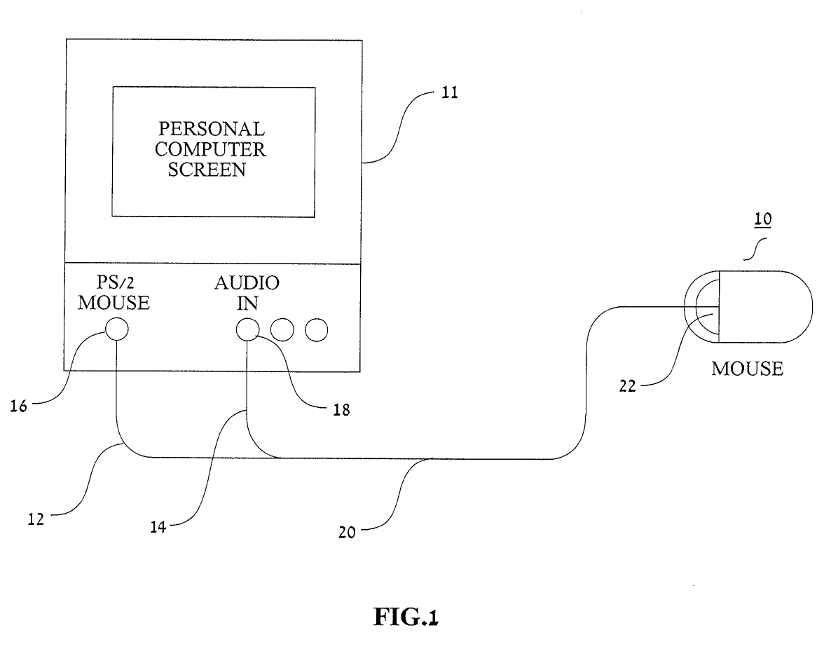

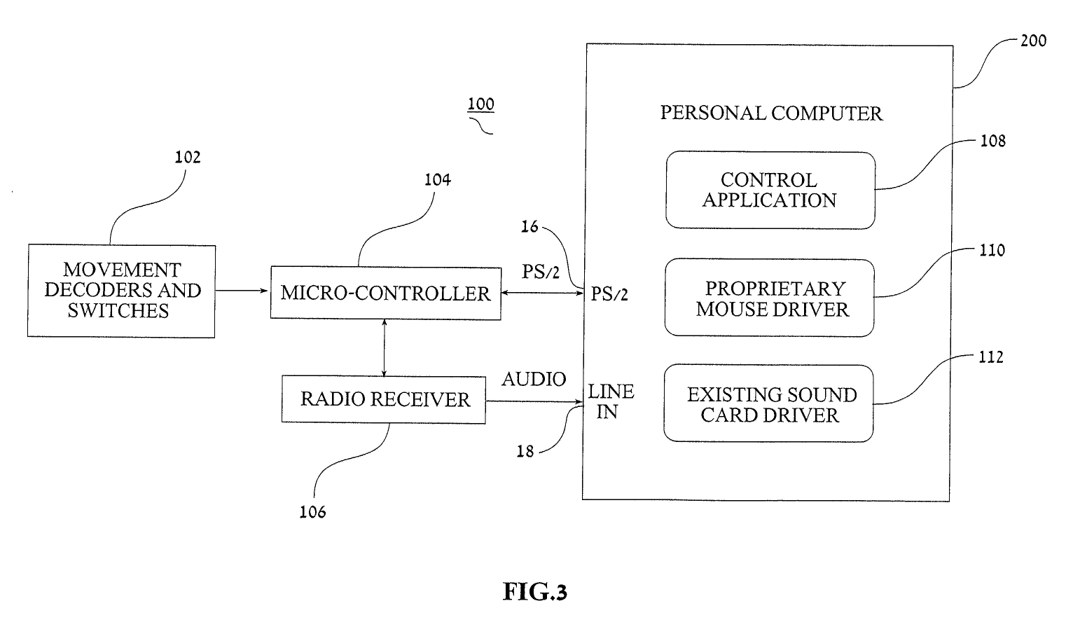

Referring now to the drawings, FIG. 1 shows a schematic description of one preferred embodiment of the system of the present invention in which both typical mouse components and radio components are integrated in an input device (mouse) 10. Device 10 thus represents the hardware part of an “integrated Radio-Mouse”. Device 10 acts like any other input device of its type known in the art. When device 10 is implemented as a mouse, it performs its mouse functions in the usual way. In addition, for the function of wireless radio-frequency reception, device 10 includes components necessary for wireless radio-frequency reception, for example a receiver, an antenna, an amplifier, a frequency filter, etc., collectively referred to herein as a “radio enabling system”. Device 10 is connected to a personal computer 11 by two, preferably wired first and second connections (communication links) 12 and 14, as follows: first connection 12 connects device 10 preferably to a PS/2 port 16 to allow two-way transfer of commands. Second connection 14 connects device 10 preferably to an Audio IN port 18 of a sound card of the computer. Connections 12 and 14 are preferably united into a single physical conduit 20 at an output port 22 of device 10. The configuration of connections 12 and 14 united into a single physical conduit 20 represents a Y connecting configuration. Received signals can be processed and made audible through computer speakers (not shown) that are connected to the computer in the usual way. The combined radio functions and normal mouse controls are controlled by an enhanced microcontroller, as described in FIG. 3 below, via an enhanced protocol, as also described in detail later in the specification.

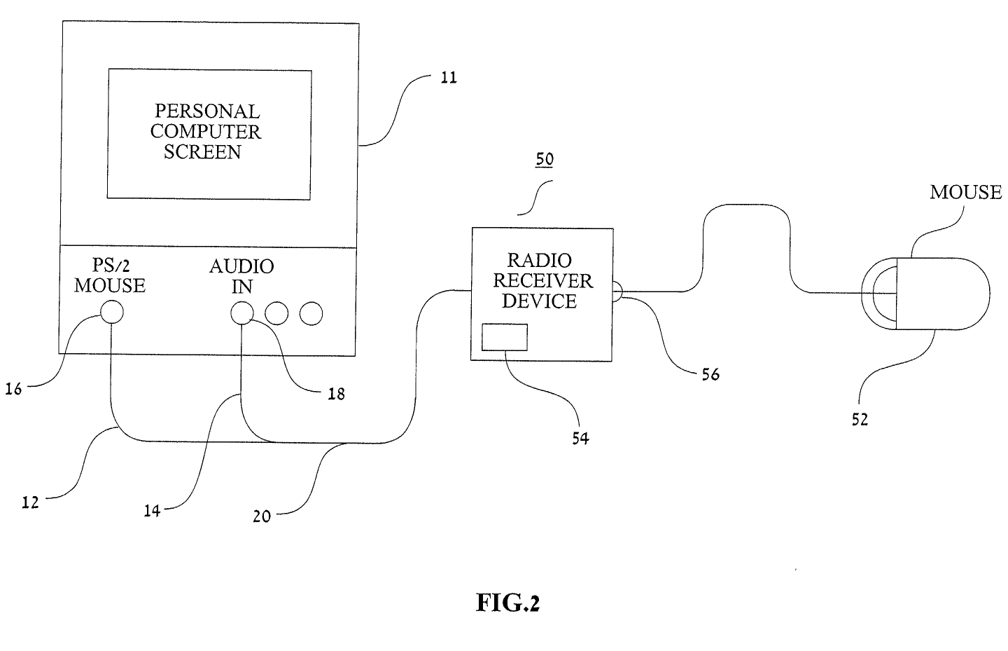

FIG. 2 shows a schematic description of another preferred embodiment of the system of the present invention, in which a wireless radio frequency receiver device 50 is physically separate from a computer input device (e.g. mouse or trackball) 52. In this embodiment, device 50 represents the hardware part of a “non-integrated Radio-Mouse”. Similarly to device 10 of FIG. 1, device 50 is comprised of known and widely available components necessary for wireless radio-frequency reception including a receiver, an antenna, an amplifier, a frequency filter, etc. (not shown), and is connected to computer 11 preferably through the same Y connecting configuration. In addition, device 50 includes an enhanced microcontroller 54, located preferably inside the device, and an input port 56 to which computer input device 52 can be attached. In addition to acting as a wireless radio frequency receiver, as described in more detail below, device 50 is also configured to relay two-way commands between computer input device 52 and the computer. Microcontroller 54 controls the radio function while rendering transparent the mouse communication.

As described above, the hardware part of the Mouse-Radio system of the present invention is preferably connected to the personal computer using the standard PS/2 interface and an analog audio interface. As shown, a single conduit splitting into two connectors connected to two PC ports connects the mouse to the rear side of the computer.

FIG. 3 is a schematic block-diagram of a preferred embodiment of a Mouse-Radio system 100 according to the present invention. As stated above, Mouse-Radio system 100 includes a number of hardware and software components, shown as blocks in the block diagram. In common with the regular PS/2 mouse subsystem, these components include a movement (motion) sensors and switches block 102, as well as other well known mouse subsystem parts (not shown), such as a mouse controller, a PS/2 communication link, a keyboard/mouse controller and a mouse driver. In addition, Mouse-Radio 100 includes an enhanced microcontroller block 104, and a radio-receiver 106, as well as three software modules used for control and normally residing inside a personal computer 200: a Windows control application module 108 (or another device driver that is operating system oriented), a special (in the sense of not being the normal Microsoft) mouse driver 110, and an existing sound card driver 112. Microcontroller 104 handles three parallel tasks. It decodes the information from movement decoders and switches 102, manages the PS/2 interface and controls the digital I/O of radio receiver 106. Thus, microcontroller 104 provides an enhanced functionality over that of a normal mouse controller that is embedded in the mouse. Normal mouse controller functions, as well as the PS/2 pinout and line protocols are well known. More information may be found by reading off-the-shelf mouse controller manuals, datasheets, and application notes, for example for the GL310MC3D5B-PS/2 3D5B Mouse controller from Genesys Logic, Inc. 10F, No. 11, Ln. 3, Tsao Ti Wei, Shenkeng, Taipei, Taiwan, or for the TEA5757-AM/FM Digitally controlled radio, from Phillips Semiconductors, International Marketing & Sales Communications, Building BE-p, P.O. Box 218,5600 MD EINDHOVEN, The Netherlands.

Special mouse driver 110 enables the control of the radio functionalities together with normal mouse activity. Control application 108 controls the radio using mouse driver 110 and also interfaces with existing sound card driver 112 for volume adjustment and similar tasks.

As should be clear to one skilled in the art, some of the components, such as the frequency filter, may be implemented as software instead of hardware. In some cases the amplifier may not be necessary.

The software acts as a control system of the receiver and replaces the buttons and other controls found in prior-art wireless radio-frequency receivers. Other functions such as recording and preprogramming are easily implemented by components already found in the computer.

Operation

The Mouse-Radio is designed to use the PS/2 mouse interface for radio control in a way that will not interfere with normal mouse operation, for example allow control of the radio without phenomena such as mouse cursor jumps or freezes. This special and innovative function is facilitated by special mouse driver 110. When an application is started, mouse driver 110 checks if the radio mouse is in use. If the mouse is not in use, mouse driver 110 resumes its function as a normal mouse driver, and the application gets some error code. If the mouse radio is found (i.e. is in use), the driver enables the application to send commands and get status from the radio circuit.

The main idea in using the same protocol for both mouse and radio features is to send short radio control and status commands or signals, while the mouse is in a HOLD communication state. When in HOLD communication state, mouse microcontroller 104 keeps tracking the mouse movements and stores them until the HOLD communication is deactivated. In a typical case, the driver sends a STOP command to the mouse, then communicates with the radio, and returns the mouse to normal operation by sending a GO command.

As mentioned, the microcontroller enhances the functionality of a normal mouse controller by adding to the normal mouse features a radio receiver interface. As a mouse controller it decodes the information from the movement detectors and switches. This information is translated into XY relative movements (XY change in position since last packet transmission) and switches state. This information is typically sent as information packets (3-5 bytes) to the computer.

A first important feature provided by the system is the accumulation of movement information for a few milliseconds while the PS/2 serial protocol is used to transfer radio commands and status. Stopping the mouse from using the PS/2 interface is done by using MOUSE-DISABLE (PS/2 Mouse command 0×F5 (hexadecimal notation)) and MOUSE-ENABLE (Mouse command 0×F4) commands. This feature of stopping the mouse from sending information exists in the normal PS/2 mouse, but is rarely used. One should notice that no mouse movement data is lost, since the movements are accumulated and are sent in the information packet following the MOUSE-ENABLE command.

A second important feature of the normal PS/2 mouse is the limited number of legal computer to mouse commands. Mouse commands are always in the range 0×E0-0×FF. Sending commands from the computer to the mouse in the range 0×00-0×DF will not be identified by normal mouse, and the mouse will reply with a RESEND status byte (mouse status byte 0×FE).

A third PS/2 mouse feature that is used by the Radio-Mouse is the MOUSE GET ID (0×F2) command. This feature is used to check the mouse type among: Basic 2-buttons, 3-buttons+wheel Microsoft IntelliMouse and 5-buttons wheel Microsoft IntelliMouse. After reset, all mouse types return ID=0. Windows then tries to upgrade the interface by sending a series of SET SAMPLING RATE (0×F3) commands. For example, sending the following series of commands:

1. SET SAMPLING RATE=200 (0×F3, 0×C8)

2. SET SAMPLING RATE=100 (0×F3, 0×64)

3. SET SAMPLING RATE=80 (0×F3, 0×50)

upgrades the mouse interface from Basic 2 button to IntelliMouse 3-buttons. After sending the above series of commands, Windows checks for mouse ID. The Basic mouse will return ID=0×00, while the IntelliMouse 3-buttons will return ID=0×03.

Digital Radio Tuner Circuit

Off-the-shelf radio tuner integrated circuits and chipsets exist and can be easily obtained. One may easily build a radio using the manufacturer application notes and design examples. In both preferred embodiments of the present invention, one can use a digitally controlled radio integrated circuit, for example (IC) TEA5757 from Phillips. Similar circuits are available from other manufacturers. The TEA5757 is controlled by the microcontroller using a serial interface. It is important to notice that the chip status may be read by serially reading 25 bits by the microcontroller, removing the dummy bit (bit 15) and sending 3 bytes to the host computer. A command to the chip may be done by sending three bytes from the host to the microcontroller. The microcontroller then adds the dummy bit and writes the whole 25 bits command to radio IC TEA5757. The radio chip acts as an autonomous entity, and its communication with the host is needed only when the user requires a new frequency (station). After sending a command for frequency set or scan, the driver waits for the radio to confirm new settings. From here on, until a next change is needed, no further attention is needed.

PS/2 Host Controller and Driver Operation

The interface between the main CPU of the PC and the keyboard/mouse is controlled by a dedicated microcontroller located on the motherboard. The details of the microcontroller and its connections may be found in PC hardware literature. For the present discussion only two I/O ports, 0×60 and 0×64 need some explanation. In order to send a command to the mouse, the software driver should write the byte 0×D4 to port number 0×64, and then write the mouse command (for example 0×F4 that was explained before) to port 0×60. Mouse response may then be found in port 0×60.

Radio Protocol Multiplexing—Radio Command

As mentioned above, sending a command to the mouse requires a mouse command that is not in the range 0×E0-0×FF. In order to send a three-byte mouse command we use the mouse command 0×80 followed by three bytes. This is typically done using the following protocol:

| Direction | Command | Remarks |
|---|---|---|
| Computer −> Mouse | 0xF5 | Mouse disable |
| Computer <− Mouse | 0xFA | Confirm |
| Computer −> Mouse | 0x80 | Special radio command |
| Computer <− Mouse | 0xFA | Confirm |
| Computer −> Mouse | 0x?? | Command byte 1 |
| Computer <− Mouse | 0xFA | Confirm |
| Computer −> Mouse | 0x?? | Command byte 2 |
| Computer <− Mouse | 0xFA | Confirm |
| Computer −> Mouse | 0x?? | Command byte 3 |
| Computer <− Mouse | 0xFA | Confirm |
| Computer −> Mouse | 0xF4 | Mouse enable |
| Computer <− Mouse | 0xFA | Confirm |

Radio Protocol Multiplexing—Radio Status

As mentioned earlier reading the radio status requires a mouse command that is not in the range 0×E0-0×FF. In order to read a three-byte mouse status we use the mouse command 0×81 and then read three bytes. This is typically done by the following protocol:

| Direction | Command | Remarks |
|---|---|---|
| Computer −> Mouse | 0xF5 | Mouse disable |
| Computer <− Mouse | 0xFA | Confirm |
| Computer −> Mouse | 0x81 | Special radio command |
| Computer <− Mouse | 0xFA | Confirm |
| Computer <− Mouse | 0x?? | Status byte 1 |
| Computer <− Mouse | 0x?? | Status byte 2 |
| Computer <− Mouse | 0x?? | Status byte 3 |
| Computer −> Mouse | 0xF4 | Mouse enable |
| Computer <− Mouse | 0xFA | Confirm |

Radio Protocol Multiplexing—Verifying the Existence of the Radio-Mouse

As mentioned earlier the driver should verify that a Radio-Mouse exists before sending non-standard mouse commands. This is typically done is a similar manner to the Microsoft upgrading protocol mentioned earlier, by sending sampling rate 0×80 three times, for example through the following protocol:

| Direction | Command | Remarks |
|---|---|---|
| Computer −> Mouse | 0xF3 | Mouse set rate |
| Computer <− Mouse | 0xFA | Confirm |
| Computer −> Mouse | 0x50 | Rate = 80 |
| Computer <− Mouse | 0xFA | Confirm |
| Computer −> Mouse | 0xF3 | Mouse set rate |
| Computer <− Mouse | 0xFA | Confirm |
| Computer −> Mouse | 0x50 | Rate = 80 |
| Computer <− Mouse | 0xFA | Confirm |
| Computer −> Mouse | 0xF3 | Mouse set rate |
| Computer <− Mouse | 0xFA | Confirm |
| Computer −> Mouse | 0x50 | Rate = 80 |
| Computer <− Mouse | 0xFA | Confirm |
| Computer −> Mouse | 0xF2 | Get device type (ID) |
| Computer <− Mouse | 0xFA | Confirm |
| Computer <− Mouse | 0x55 | Radio mouse (0, 3 or 4 for |
| | | normal mouse) |

Further Aspects of the Invention

Since the device controls are implemented as software installed on the computer, it is possible to use the device in a number of ways, as desired. For example: a) One can place customized display and control panels on the computer screen, dependent on specific user and design considerations; b) Programming of radio reception and recording can be easily performed. The user can decide to preprogram the receiver to turn on and off at specific times and dates for the purposes of listening or recording. Desired stations can be marked. Frequency scanning can be performed to find desired programming types or stations; c) The software can easily be upgraded or modified, or options can be added by connecting to the supplier of the present invention through the Internet. Through the Internet, programming scheduling can be accessed or downloaded.

In summary, by adding the hardware components necessary for wireless radio-frequency reception (preferably implemented as a simple and cheap printed circuit) into a computer input-device (such as a computer mouse), by providing an enhanced protocol and a special driver as well as other components including control software installed on the computer, and by using the sound card and speaker already installed on the computer, wireless radio-frequency reception and auditing on a personal computer is made possible.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made.

Although the example above refers specifically to FM radio reception, it is clear to one skilled in the art that using the teachings of the present invention and with suitable modification, reception of other frequencies and bands can be implemented.

What is claimed is:

1. A system for the combined input of data into a personal computer and for reception of wireless radio-frequency signals, comprising:
a. an integrated computer input device including a PS/2 mouse interface and configured to receive wireless radio frequency signals,
b. an enhanced protocol for controlling said reception of radio frequency signals while rendering transparent the input of data, and
c. a special mouse driver used for performing said enhanced protocol, whereby the system uses said PS/2 mouse interface for radio control in a way that does not interfere with normal mouse operation.

2. The system of claim 1, wherein said integrated input device further includes two connections to the personal computer, one to a PS/2 port and one to an audio port, and an enhanced microcontroller for performing normal input device control functions while adding features of a radio receiver interface.

3. The system of claim 2, wherein said enhanced protocol includes radio protocol multiplexing.

4. The system of claim 3, wherein said radio protocol multiplexing includes multiplexing operations selected from the group consisting from radio command, radio status and verification of the existence of said computer input device.

5. A system for the combined input of data into a personal computer and for reception of wireless radio-frequency signals, comprising:
a. a computer input device including a PS/2 mouse interface,
b. a wireless radio frequency receiver device connected to said input device,
c. an enhanced protocol for controlling said reception of radio frequency signals while rendering transparent the input of data, and
d. a special mouse driver used for performing said enhanced protocol, whereby the system uses said PS/2 mouse interface for radio control in a way that does not interfere with normal mouse operation.

6. The system of claim 5, wherein said input device further includes two connections to the personal computer, one to a PS/2 port and one to an audio port, and a separate microcontroller for adding features of a radio receiver interface to normal input device control functions.

7. The system of claim 6, wherein said enhanced protocol includes radio protocol multiplexing.

8. The system of claim 7, wherein said radio protocol multiplexing includes multiplexing operations selected from the group consisting from radio command, radio status and verification of the existence of said computer input device.
